(19) United States
(12) Patent Application Publication
(10) Pub. No.: US 2010/0225855 A1
(43) Pub. Date: Sep. 9, 2010

(54) NORMALLY BLACK TRANSFLECTIVE LIQUID CRYSTAL DISPLAYS

(75) Inventor: Ruibo Lu, San Bruno, CA (US)

Correspondence Address: HICKMAN PALERMO TRUONG & BECKER, LLP, 2055 GATEWAY PLACE, SUITE 550, SAN JOSE, CA, 95110, US

(73) Assignee: Pixel Qi Corporation, San Bruno, CA (US)

(21) Appl. No.: 12/560,217

(22) Filed: Sep. 15, 2009

Related U.S. Application Data
(60) Provisional application No. 61/158,398, filed on Mar. 9, 2009.
(60) Provisional application No. 61/159,441, filed on Mar. 11, 2009.
(60) Provisional application No. 61/159,442, filed on Mar. 12, 2009.
(60) Provisional application No. 61/160,685, filed on Mar. 16, 2009.

(51) Int. Cl. G02F 1/1335; G02F 1/13

(52) U.S. Cl. 349/96; 349/114; 349/106; 349/187

(57) ABSTRACT

Techniques are provided for normally black multi-mode LCDs using homogeneously aligned liquid crystal materials which optical birefringence is electrically controllable. A light recycling/redirecting film may be added between a BLU and a nearby polarization layer to recycle backlight from a reflective part of an LCD unit structure into a transmissive part of the same structure to increase the optical output efficiency of the BLU. Electrodes for the transmissive part and the reflective part may be separately driven in various operating modes. Benefits include high transmittance, high reflectance, wide view angles, improved optical recycling efficiency, and low manufacturing costs.

This application claims the benefit, under 35 U.S.C. 119(e), of prior provisional application 61/158,398, filed Mar. 9, 2009, prior provisional application 61/159,441, filed Mar. 11, 2009, prior provisional application 61/159,442, filed Mar. 12, 2009, prior provisional application 61/160,685, filed Mar. 16, 2009, the entire contents of which are hereby incorporated by reference for all purposes as if fully set forth herein.

### CROSS REFERENCE TO RELATED APPLICATIONS

This application is related to U.S. patent application Ser. No. 12/503,793, filed Jul. 15, 2009, the entire contents of which are hereby incorporated by reference for all purposes as if fully disclosed herein.

### TECHNICAL FIELD

The present disclosure relates to Liquid Crystal Displays (LCDs).

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A transflective LCD, which comprises an array of pixels or sub-pixels each having a reflective part and a transmissive part, may be used in cell phones, electronic books, and personal computers in part because readability of the transflective LCD typically is not limited by ambient lighting conditions. The reflective part and the transmissive part in a pixel or sub-pixel of the transflective LCD may be simultaneously used to express a single pixel or sub-pixel value. However, when only one of the reflective part and the transmissive part is used to express a pixel or sub-pixel value, the remaining part sometimes distorts the overall luminance level of the pixel or sub-pixel.

A normally white transflective LCD may use a compensation retarder such as a nematic-hybrid retarder to place one of a transmissive part and a reflective part of a pixel in a dark black state to prevent distortion of the overall luminance level of the pixel. However, the compensation retarder is typically expensive and the incorporation of the compensation retarder into the normally white transflective LCD complicates the fabrication process.

Further, additional power consumption is required to turn a normally white pixel into the dark black state in operation. Thus, in a conventional LCD, nearly 75% of the battery power would be consumed by a backlight unit (BLU).

### BRIEF DESCRIPTION OF THE DRAWINGS

Various embodiments of the present invention will herein after be described in conjunction with the appended drawings, provided to illustrate and not to limit the present invention, wherein like designations denote like elements, and in which:

FIG. 1A illustrates a schematic cross-sectional view of an example normally black transflective Electrically-Controlled-Birefringence (ECB) LCD unit structure in a voltage-off state.

FIG. 1B illustrates a schematic cross-sectional view of an example normally black transflective ECB LCD unit structure in a voltage-on state.

FIG. 2A illustrates a schematic cross-sectional view of an example normally black transflective Fringe-Field-Switching (FFS) LCD unit structure in a voltage-off state.

FIG. 2B illustrates a schematic cross-sectional view of an example normally black transflective FFS LCD unit structure in a voltage-on state.

FIG. 3A illustrates a schematic cross-sectional view of an example normally black transflective Flower-like-Electrode-Configuration (FEC) LCD unit structure in a voltage-off state.

FIG. 3B illustrates an example electrode substructure in an example normally black transflective FEC LCD unit structure.

FIG. 3C illustrates a schematic cross-sectional view of an example normally black transflective FEC LCD unit structure in a voltage-on state.

FIG. 4 illustrates an example backlight recycling scheme that may be used with any of the LCD unit structures.

The drawings are not rendered to scale.

### DETAILED DESCRIPTION

Techniques for normally black (NB) transflective LCDs are described. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

1. GENERAL OVERVIEW

In embodiments, the normally black transflective LCDs use backlight, or additionally ambient light, to show color images in a transmissive or transflective operating mode, and use only ambient light to show black-and-white images in a reflective operating mode. In embodiments, the normally black transflective LCDs has wide view angles. In embodiments, the normally black transflective LCDs have fewer retardation films and incur lower manufacturing costs than otherwise. In embodiments, the normally black transflective LCDs exhibit good ambient light readability and low power consumption.

In embodiments, a unit structure of a normally black transflective LCD comprises a homogenously aligned liquid crystal layer in both a reflective part and a transmissive part. As used herein, “a homogenously aligned liquid crystal layer” means that in a voltage-off state, the liquid crystal layer remains homogeneously aligned to a same direction within each of the transmissive part and the reflective part; however, the liquid crystal layer portion in the transmissive part may or may not be aligned with the liquid crystal layer portion in the reflective part. In embodiments, the normally black transflective LCD unit structure shows high transmittance in the transmissive part and high reflectance in the reflective part. In embodiments, backlight in the reflective part of a normally black transflective LCD unit structure is re-circulated into the transmissive part.

In embodiments, a transflective liquid crystal display comprises a plurality of unit structures, each unit structure comprising a reflective part and a transmissive part. The reflective part comprises first portions of a first polarizing layer, a second polarizing layer, a first substrate layer, and a second substrate layer, wherein the second substrate layer is opposite to the first substrate layer; a first common electrode portion; a reflective electrode; an over-coating layer adjacent to one of the first substrate layer and the second substrate layer; a reflective layer adjacent to the first substrate layer; a half-wave retardation film; wherein the first substrate layer and the second substrate layer are between the first polarizing layer and the second polarizing layer; a first liquid crystal layer portion of a liquid crystal layer between the first substrate layer and the second substrate layer, wherein liquid crystal molecules in the first liquid crystal layer portion is substantially homogeneously aligned along a first direction in a voltage-off state. The transmissive part comprises second portions of the first polarizing layer, the second polarizing layer, the first substrate layer, and the second substrate layer; a second liquid crystal layer portion of the liquid crystal layer between the first substrate layer and the second substrate layer; a second common electrode portion; and a transmissive electrode; wherein a cell gap of the first liquid crystal layer portion is different from a cell gap of the second liquid crystal layer portion; wherein liquid crystal molecules in the second liquid crystal layer portion is substantially homogeneously aligned along a second direction in the voltage-off state. In some embodiments, the first direction and the second direction are the same in the voltage-off state, while in some other embodiments, the first direction and the second direction are different in the voltage-off state.

In embodiments, the unit structure further comprises at least one color filter that covers at least an area of the transmissive part, wherein the unit structure is configured to express a color value associated with a color of the at least one color filter. In some of these embodiments, the unit structure is a part of a composite pixel, which comprises another unit structure that is configured to express a different color value other than the color value expressed by the unit structure.

In some embodiments, a normal direction of a surface of the first substrate layer is aligned in parallel with one or more of the first direction and the second direction. In some other embodiments, wherein the unit structure further comprises one or more orientation films and wherein one or more of the first direction and the second direction are along a rubbing direction of at least one of the one or more orientation films.

In embodiments, the half-wave retardation film is an in-cell retardation film that covers substantially only the reflective part.

In embodiments, the unit structure comprises a first half-wave film and a second half-wave film each comprising a first portion in the reflective part and a second portion in the transmissive part; the half-wave retardation film is the first portion of the second half-wave film in the reflective part.

In some embodiments, the second half-wave film is a uni-axial retardation film. In some other embodiments, the second half-wave film is a biaxial retardation film, or alternatively an oblique retardation film.

In embodiments, the liquid crystal layer comprises a liquid crystal material which optical birefringence is electrically controllable.

In embodiments, the half-wave retardation film and the first liquid crystal layer portion forms a wideband quarter-wave plate in the voltage-off state. In some of these embodiments, the half-wave retardation film has an azimuth angle of θh; the first liquid crystal layer portion has an azimuth angle of θq; and the azimuth angles satisfy one of (1) 60≦4θh−2θq≦120, or (2) −120≦4θh−2θq≦−60. In some of these embodiments, θq is one of (1) 0° or 90° or (2) 10° or 100° within an angular variation of ±5°.

In embodiments, the unit structure comprises a first half-wave film and a second half-wave film, wherein the half-wave retardation film is a first portion of the second half-wave film, wherein the half-wave retardation film and the first liquid crystal layer portion in the voltage-off state forms a wideband quarter-wave plate in the reflective part, wherein a second portion of the second half-wave film and a first half of the second liquid crystal layer portion in the voltage-off state forms a first wideband quarter-wave plate in the transmissive part, and wherein the first half-wave film and a second remaining half of the second liquid crystal layer portion in the voltage-off state forms a second wideband quarter-wave plate in the transmissive part. In some of these embodiments, the first half-wave film has an azimuth angle of θh; the first liquid crystal layer portion has an angle of θq, wherein an azimuth angle of the second half-wave film is substantially θh, and wherein the azimuth angles satisfy one of (1) 60≦4θh−2θq≦120, or (2) −120≦4θ h−2θq≦−60. In some of these embodiments, θq is one of (1) 0° or 90° or (2) 10° or 100° within an angular variation of ±5°.

In embodiments, the unit structure comprises a first half-wave film, a second half-wave film, a first quarter-wave film, and a second quarter-wave film, wherein the half-wave retardation film is a part of the second half-wave film, wherein the first half-wave film and the first quarter-wave forms a first wideband quarter-wave plate in both the transmissive part and the reflective part, and wherein the second half-wave film and the second quarter-wave forms a second wideband quarter-wave plate in both the transmissive part and the reflective part. In some of these embodiments, the first half-wave film has an azimuth angle of θh; the first quarter-wave film has an azimuth angle of θq; an azimuth angle of the second half-wave film is substantially Oh; an azimuth angle of the second quarter-wave film is substantially Oh; and the azimuth angles satisfy one of (1) 60≦4θh−2θq≦120, or (2) −120≦4θh−2θq≦−60. In some of these embodiments, θq is one of (1) 0° or 90° or (2) 10° or 100° within an angular variation of ±5°.

In embodiments, the unit structure comprises a switching element that is configured to control whether the reflective electrode is electrically connected to the transmissive electrode. In some of these embodiments, the switching element comprises one or more thin-film transistors.

In embodiments, at least one of the common electrode and a combination of the transmissive electrode and the reflective electrode comprises two spatial parts that are located on different planes.

In embodiments, the common electrode is located on a first side of the liquid crystal layer and the transmissive electrode and the reflective electrode are located on a second opposing side of the liquid crystal layer.

In embodiments, the common electrode, the transmissive electrode, and the reflective electrode are located on a same side of the liquid crystal layer; the unit structure further comprises a passivation layer; the common electrode is located on a first side of the passivation layer; and the transmissive electrode and the reflective electrode are located on a second opposing side of the passivation layer.

In embodiments, at least one of the common electrode, the transmissive electrode and the reflective electrode is formed by a non-perforated planar layer of a conductive material.

In embodiments, at least one of the common electrode, the transmissive electrode, and the reflective electrode is formed by a plurality of discrete conductive components; two neighboring discrete conductive components is spatially separated by a non-conductive gap.

In embodiments, at least one of the common electrode, the transmissive electrode, and the reflective electrode comprises one or more openings each of which is void of a conductive material. In some of these embodiments, at least one of the one or more openings has a symmetric shape.

In embodiments, one or more micro-protrusions are deposited on at least one of the common electrode, the transmissive electrode, and the reflective electrode. In some of these embodiments, at least one of the one or more micro-protrusions is a solid dielectric material. In some embodiments, at least one of the one or more micro-protrusions is coated with a conductive material.

In embodiments, the common electrode comprises one or more openings each of which is void of a conductive material; one or more micro-protrusions are deposited on the transmissive electrode and the reflective electrode; the one or more openings and the one or more micro-protrusions form one or more pairs of electrode substructures each comprising one of the one or more openings and one of the one or more micro-protrusions.

In embodiments, at least one of the common electrode, the transmissive electrode, and the reflective electrode comprises a transparent conductive material.

In embodiments, the reflective electrode is the reflective layer.

In embodiments, the unit structure further comprises a light recycling film between the first substrate layer and a backlight unit that redirects backlight from the reflective part to the transmissive part. In some of these embodiments, the light recycling film is configured to turn incident light of any polarized state into redirected light with a particular polarization state.

In some embodiments, a transflective LCD as described herein forms a part of a computer, including but not limited to a laptop computer, netbook computer, cellular radiotelephone, electronic book reader, point of sale terminal, desktop computer, computer workstation, computer kiosk, or computer coupled to or integrated into a gasoline pump, and various other kinds of terminals and display units.

In some embodiments, a method comprises providing a transflective LCD as described, and a backlight source to the transflective LCD.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

2. Structural Overview

2.1 Electrically Controlled Birefringence

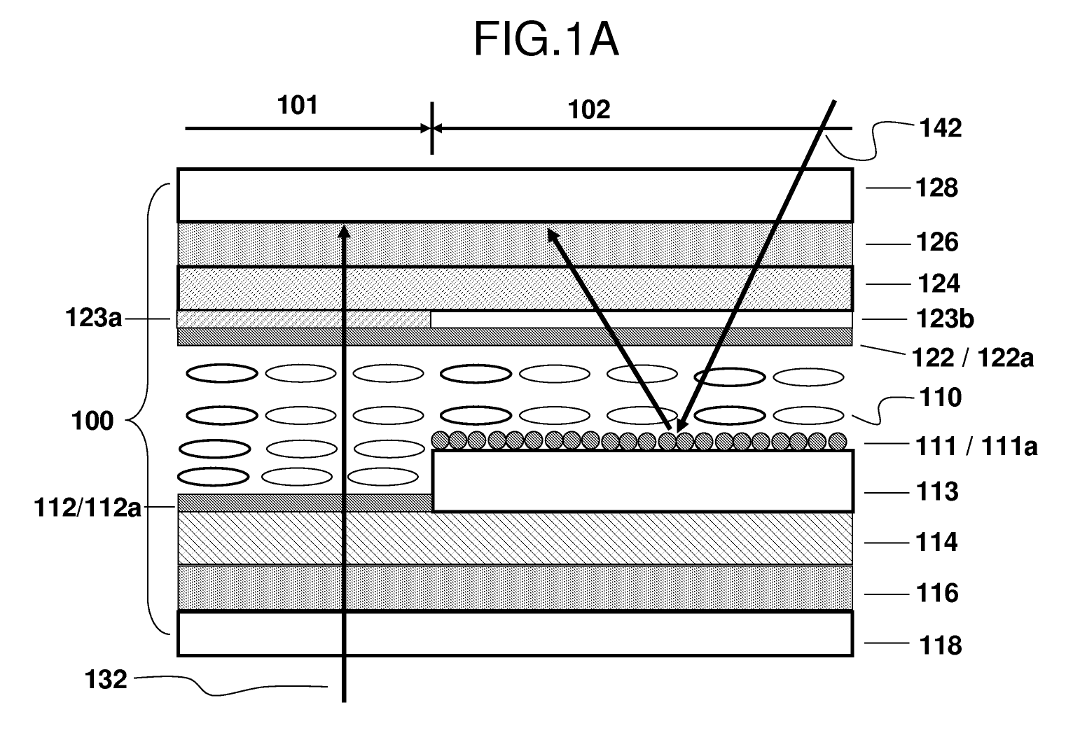

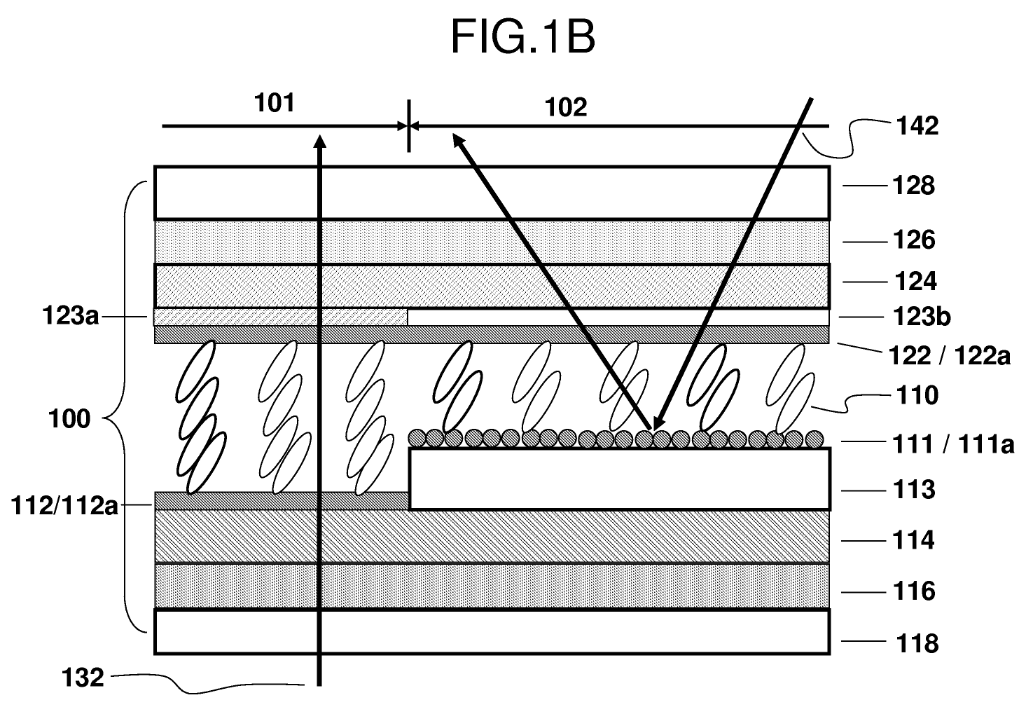

FIG. 1A illustrates a schematic cross-sectional view of an example NB transflective LCD unit structure 100 in a voltage-off state. As used in this disclosure, “a transflective LCD unit structure in a voltage-off state” means that the unit structure is in a state in which (1) a voltage is not applied to a liquid crystal layer in the unit structure or (2) even if applied, is below a threshold value to cause a deviation from the state of the liquid crystal layer when the voltage is not applied. The term “transflective LCD unit structure” may refer to a pixel or a sub-pixel in the transflective LCD. The LCD unit structure 100 may comprise two or more parts. As illustrated, the LCD unit structure 100 comprises a transmissive part 101 and a reflective part 102 along the horizontal direction of FIG. 1A. The transmissive part 101 and the reflective part 102 have different layered structures along the vertical direction of FIG. 1A.

The LCD unit structure 100 comprises a layer 110 of homogeneously aligned liquid crystal material. When both the transmissive part 101 and the reflective part 102 comprise structures to operate in an ECB mode as illustrated here, the liquid crystal layer 110 in both the transmissive part 101 and the reflective part 102 may align with a same direction in the voltage-off state. The liquid crystal layer 110 may be filled into a cell space by a capillary effect or a one-drop filling process under the vacuum condition. In the proposed embodiments, the liquid crystal layer 110 is typically of a positive dielectric anisotropy type with Δ∈>0.

The transmissive part 101 may have a different liquid crystal cell gap than that of the reflective part 102. As used in this disclosure, “a liquid crystal cell gap” refers to the thickness of the liquid crystal layer in either the transmissive part or the reflective part. For example, in some embodiments, the LCD unit structure 100 comprises an over-coating layer 113 on or near a bottom substrate layer 114 in the reflective part 102. The over-coating layer 113 may be formed in a plurality of partially etched regions by a photolithographic etching process. In various embodiments, the over-coating layer 113 may comprise acrylic resin, polyamide, or novolac epoxy resin. In some embodiments, in part due to the over-coating layer 113, the cell gap of the portion of the liquid crystal layer 110 in the reflective part 102 is approximately one half of the cell gap of the other portion of the liquid crystal layer 110 in the transmissive part.

The inner surface, which is the top surface in FIG. 1A, of over-coating layer 113 may be covered with a metallic reflective layer 111 such as aluminum (Al) or silver (Ag) to work as a reflective electrode 111a. In some embodiments, this metallic reflective layer 111 may be a bumpy metal layer.

The bottom substrate layer 114 may be made of glass. On the inner surface, which faces the liquid crystal layer 110, of the bottom substrate layer 114 in the transmissive part 101, a transparent indium-tin oxide (ITO) layer 112 may be provided as a transmissive electrode 112a.

Color filters 123a may be deposited on or near a surface of a top substrate layer 124. The color filters may cover both the transmissive part 101 and the reflective part 102, or only cover the transmissive part 101. There may be red, green and blue (RGB) color filters 123a deposited on or near the inner surface, which faces the liquid crystal layer 110, of the top substrate layer 124 in the transmissive part 101. In areas that are not covered by the color filters 123a, a second over-coating layer 123b may be configured. This second over-coating layer 123b may be a passivation layer comprising an organic material such as a-Si:C:O and a-Si:O:F, or an inorganic material such as silicon nitride (SiNx) and silicon oxide (SiO2), prepared by plasma enhanced chemical vapor deposition or other similar sputtering methods.

An ITO layer 122 may be located between the top substrate layer 124 and the liquid crystal layer 110 as a common electrode 122a. In some embodiments, this ITO layer 122 covers the whole area of the LCD unit structure.

A bottom linear polarization layer 116 and a top linear polarization layer 126 with substantially the same polarization axis may be attached on outer surfaces of the bottom substrate layer 114 and top substrate layer 124 respectively.

A switching element may be configured in the unit structure 100 to control whether the reflective electrode 111a is connected or disconnected with the transmissive electrode 112a in the transmissive part 101. For example, in some operating modes of a transflective LCD display comprising the LCD unit structure 100, the switching element, working in conjunction with display mode control logic, may cause the reflective electrode 111a to be connected to the transmissive electrode 112a; hence, the electrodes 111a and 112a may be driven by a same signal to cause the transmissive part 101 and the reflective part 102 to simultaneously express a same pixel or sub-pixel value. In some other operating modes, on the other hand, the switching element may cause the reflective electrode 111a to be disconnected from the transmissive electrode 112a; the electrodes 111a and 112a may thus be driven by separate signals to cause the transmissive part 101 and the reflective part 102 to independently express different pixel or sub-pixel values. For example, in a transmissive operating mode, the transmissive part 101 may be set according to a pixel or sub-pixel value based on image data, while the reflective part 102 may be set in a dark black state. In a reflective operating mode, on the other hand, the reflective part 102 may be set according to a pixel or sub-pixel value based on image data, while the transmissive part 101 may be set in a dark black state.

The switching element may be implemented by one or more thin-film transistors (TFTs) hidden beneath the metallic reflective layer 111 in the reflective part 102 to improve the aperture ratio of the transflective LCD.

In some embodiments, in the voltage-off state, the homogeneously aligned liquid crystal layer 110 may be aligned in a direction such that the liquid crystal layer 110 in the transmissive part 101 is substantially a half-wave plate, while the liquid crystal layer 110 in the reflective part 102 is substantially a quarter-wave plate. In different embodiments, liquid crystal materials with different electrically controllable birefringence properties may be used in the liquid crystal layer 110. In some embodiments, rubbed polyimide layers, not shown in FIG. 1A, may be formed between (1) one of ITO layers 112, 122, and the metallic reflective layer 111 and (2) the liquid crystal layer 110 to induce molecules in the liquid crystal layer 110 near the rubbed polyimide layers to be homogeneously aligned along a rubbing direction in parallel with the planar surfaces of the substrate layers 114 and 124.

In some embodiments, a first half-wave retardation film 116 is arranged above a polarization layer 118, while a second half-wave retardation film 126 are arranged below a polarization layer 128. The polarization layers 118 and 128 may have a substantially assigned polarization axis. Slow axis directions of the first and second half-wave retardation films 116 and 126, which may be the “extraordinary” or longitudinal direction of aligned molecules therein, may be substantially along a same direction in the unit structure 100. Since the liquid crystal layer 110 is a half-wave plate in the voltage-off state, backlight 132 from a BLU with a first polarization state when entering the first half-wave retardation film 116 turns into light with a second orthogonal polarization state when exiting the second half-wave retardation film 126. The light with this second orthogonal polarization state is blocked by the polarization layer 128. This produces a normally black liquid crystal mode for the transmissive part 101 of the LCD unit structure 100.

In the reflective part 102, the light path of ambient light 142 crosses the liquid crystal layer 110 twice. Since the liquid crystal layer 110 in the reflective part 102 is a quarter-wave plate in the voltage-off state, the total effect of the liquid crystal layer 110 after the light path of the ambient light 142 crosses the liquid crystal layer 110 twice is a half-wave plate. Under a similar analysis to that for the transmissive part 101, the ambient light 142 is similarly blocked in the reflective part 102 in the voltage-off state. Thus, a normally black liquid crystal mode for the reflective part 102 of the LCD unit structure 100 is also produced.

In some embodiments, azimuth angles of the first half-wave retardation film 116 and the second half-wave retardation film 126 are the same, for example, θ_{q}. In the voltage-off state, the half-wave plate formed by the liquid crystal layer 110 in the transmissive part 101 can be considered as a pair of quarter-wave plates; azimuth angles of the quarter-wave plates in the pair are also the same, for example, θ_{q}. The first half-wave retardation film 116 and one of the quarter-wave plate form a wideband quarter-wave plate, while the second half-wave retardation film 126 and the other of the quarter-wave plates form another wideband quarter-wave plate. Thus, the optical configuration of the transmissive part 101 comprises two wideband quarter-wave plates as described.

Similarly, in the reflective part 116, only the second half-wave retardation film 126 and the liquid crystal layer 110 are in the optical path of the ambient light 142. As noted, in the voltage-off state, the liquid crystal layer 110 in the reflective part 102 is a quarter-wave plate. The azimuth angles of the second half-wave retardation film 126 and the liquid crystal layer 110 are θₕ and θ_{q}, respectively. Since the optical path of the ambient light 142 crosses the second half-wave retardation film 126 and the liquid crystal layer 110 twice, the optical configuration of the reflective part 102 effectively also comprises two broadband quarter-wave with the same azimuth angles θₕ and θ_{q} as those in the optical configuration of the transmissive part 101. Depending on a choice of an optimized central wavelength in the visible range from 380 nm to 780 nm, a retardation value of the broadband quarter-wave plates may be configured with a value between 160 nm and 400 nm Further, in some embodiments, the azimuth angles θₕ and θ_{q} may be configured to satisfy one of the two relationships as follows:

60≦4θₕ−2θ_{q}≦120 (Rel. 1a)

or

−120≦4θₕ−2θ_{q}≦−60 (Rel. 1b)

In some embodiments, to realize a pair of achromatic broadband quarter-wave plates in both the transmissive and reflective part, the azimuth angles θₕ and θ_{q} may be configured to substantially satisfy a specific relationship as follows:

4θₕ−2θ_{q}=±90. (Rel. 1c)

To reduce the color dispersion of the liquid crystal layer 110 in the voltage-off state, θ_{q} may be configured to be 0° or 90° aligning with the rubbing direction, which is the liquid crystal alignment direction, with an angular variation of ±5°. In some embodiments, θₕ is set at around ±67.5° based on the relationship Rel. 1c. Since the polarizer pair is aligned parallel instead of perpendicular to each other, since the optical configurations of the transmissive part 101 and the reflective 101 substantially coincide, the LCD unit structure 100 exhibits a better gamma curve matching ability between the transmissive and reflective modes than otherwise.

FIG. 1B illustrates a schematic cross-sectional view of the example NB transflective LCD unit structure 100 in a voltage-on state. As used in this disclosure, “a transflective LCD unit structure in a voltage-on state” means that the unit structure is in a state in which a voltage is applied to a liquid crystal layer in the unit structure above a threshold value to cause a deviation from the state of the liquid crystal layer when the voltage is not applied.

As illustrated in FIG. 1B, in the transmissive part 101, in the voltage-on state, the homogenously aligned Liquid crystal layer 110 will be tilted up by an ECB effect due to dielectric anisotropy of the liquid crystal material in layer 110. The tilting of the liquid crystal material in layer 110 induces an optical anisotropic change. This optical anisotropic change causes the liquid crystal layer 110 in the transmissive part 101 no longer to be a half-wave plate. Consequently, the backlight 132, which is blocked in the voltage-off state, can now pass through the polarization layers 118 and 128 to show a bright state in the transmissive part 101.

Similarly, in the reflective part 102, in the voltage-on state, the homogenously aligned liquid crystal layer 110 will be tilted up by an ECB effect due to dielectric anisotropy of the liquid crystal material in layer 110. This tilting of the liquid crystal material in layer 110 induces an optical anisotropic change. This change causes the liquid crystal layer 110 in the reflective part 102 no longer to be a quarter-wave plate. Consequently, the ambient light 142, which is blocked in the voltage-off state, can now be reflected off from the metallic reflective layer 111 to show a bright state in the reflective part 102.

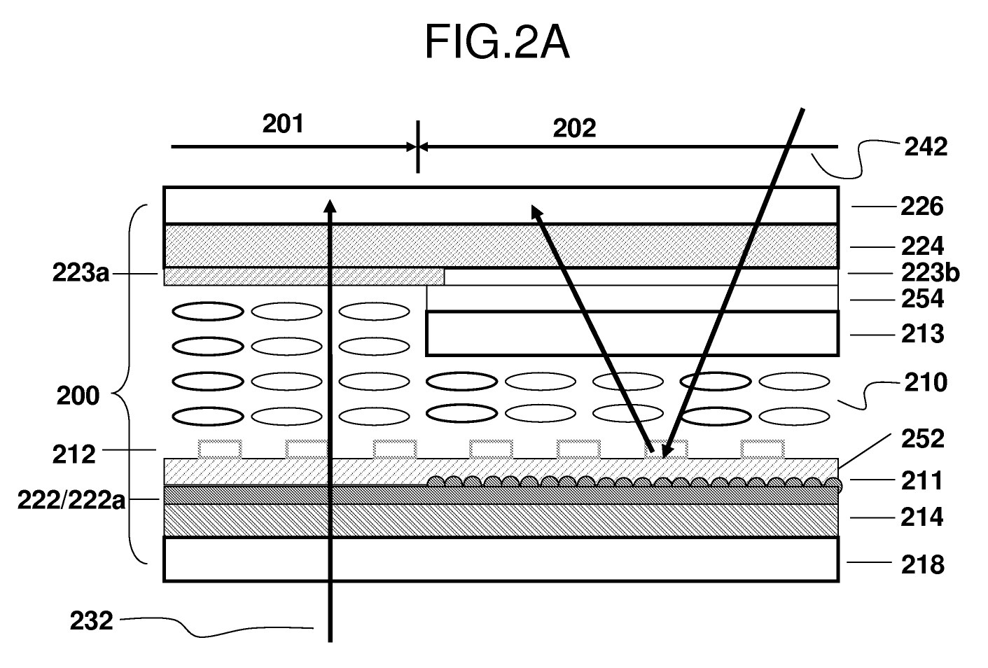

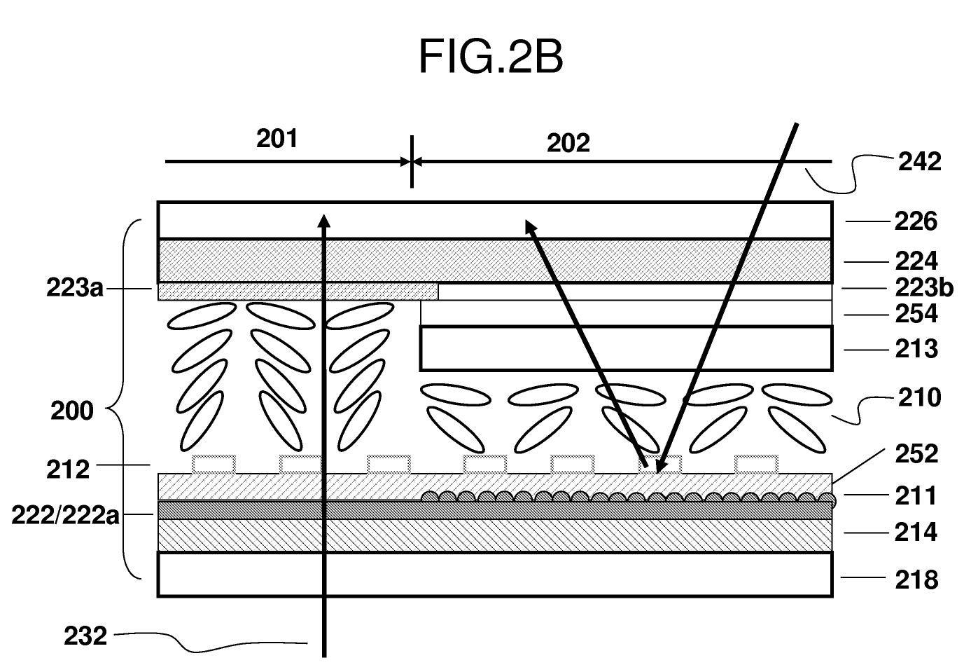

To illustrate a clear example, both the transmissive part 101 and the reflective part 102 in FIG. 2B are in the voltage-on state. However, in some embodiments, the voltage-on state of the transmissive part 101 and the voltage-on state of the reflective part 102 may be independently set. For example, when the switching element as described causes the reflective electrode 111a to connect to the transmissive electrode 112a, both the transmissive part 101 and the reflective part 102 may be set to a luminance state based on a same pixel value. When the reflective electrode 111a is disconnected to the transmissive electrode 112a, on the other hand, the transmissive part 101 may be set to a first brightness state while the reflective part 102 may be independently set to a second different brightness state.

In some embodiments, color images can be displayed in combination with the R.G.B. color filters 123a in the transmissive part 101 in the transmissive or transflective operating modes, while black-and-white images can be shown in the reflective part 102 in the reflective operating modes.

In some embodiments, parameters for the liquid crystal layer 110 are: birefringence Δn=0.067, dielectric anisotropy Δ∈=6.6 and rotational viscosity γ1=0.143 Pa·s. The liquid crystal layer 110 has homogenous alignment in the initial voltage-off state. The azimuth angle Oh for the liquid crystal layer 110 is 0°. The pre-tilt angle for the liquid crystal layer 110 is within 2°. Table 1 shows additional parameters for the LCD unit structure in the embodiment, with an area ratio 40:60 between the transmissive part 101 and the reflective part 102.

TABLE 1

| Components | | Example value |
|---|---|---|
| Polarization layer 118 | absorption axis (°) | 0 |
| Half-wave film 116 | slow axis direction (°) | 67.5 |
| | phase retardation (nm) | 275 |
| LC layer 110 in transmissive | alignment direction (°) | 0 |
| part 101 | cell gap (μm) | 4 |
| LC layer 110 in reflective part | alignment direction (°) | 0 |
| 102 | cell gap (μm) | 2 |
| Half-wave film 126 | slow axis direction (°) | 67.5 |
| | phase retardation (nm) | 275 |
| Polarization layer 128 | absorption axis (°) | 0 |

In some embodiments, the first and second half-wave retardation films 116 and 126 are made of uni-axial retarders. The maximum normalized transmittance for the LCD unit structure 100 with the above example parameter values and with uni-axial retarders is 99.98%, 97.32% and 79.70% to the RGB primaries, respectively. The maximum normalized transmittance for an example normally white transflective ECB LCD is 98.81%, 81.08% and 59.38% at λ=450 nm, 550 nm and 650 nm, respectively. The NB transflective LCD unit structure 100 has a gain of 1.17%, 16.24% and 20.32% in transmittance of the RGB primaries over those of the conventionally normally white transflective ECB LCD. The NB transflective LCD unit structure 100 has a maximum normalized reflectance of 93.59%, while that of the conventionally normally white transflective LCD has a maximum normalized reflectance of 87.11%. Therefore, the NB transflective LCD 100 has a gain of 6.48% in reflectance over that of the conventionally normally white transflective ECB LCD.

In the transmissive part 101, the NB transflective LCD 100 with an applied voltage between 0 Vrms and 5 Vrms and white light emitting diodes (LEDs) as the BLU achieves a high contrast ratio of 300:1 within a view cone of around ±15° and a contrast ratio bar of 10:1 of around ±40°.

In contrast, an example conventionally normally white transflective ECB LCD with an applied voltage between 0 Vrms and 3 Vrms under the same backlight conditions may achieve a contrast ratio of 300:1 at the normal incident direction. However, the view cone is narrowed to only ±5°. As for the contrast ratio bar of 10:1, the range for the conventional ECB LCD is only around ±30°.

Therefore, the NB transflective LCD 100 has a wider view angle than that of the conventionally normally white transflective ECB LCD.

Small-sized portable displays may be frequently tilted and viewed from oblique viewing angles by users. The NB transflective LCD 100 under “D65” ambient light conditions with the obliquely incident angle of 45° and with an applied voltage between 0 Vrms and 5 Vrms in the reflective part can realize a contrast ratio of 10:1 at a wide view cone of around ±40°, and a contrast ratio of larger than 1 nearly on the whole display view cone of ±80°. Thus, black-and-white images on a display using the LCD unit structure 100 can be read under the ambient light conditions with no grayscale reversion.

In some embodiments, instead of using uni-axial retarders, the first and second half-wave retardation films 116 and 126 may be made of other types of anisotropic retarders. For example, biaxial retarders and oblique retarders may also be used. In embodiments where biaxial retarders are used as the first and second half-wave retardation films 116 and 126, either negative or positive biaxial retarders may be used.

In some embodiments where negative biaxial retarders are used as the half-wave retardation films 116 and 126, Nz may be chosen in a range. Nz is defined as (nx−nz)/(nx−ny). An example range for possible Nz values may be 0.2≦Nz≦0.9. In one embodiment, Nz may be 0.35. Under the similar cell configuration as previously described and a TFT driving voltage, the viewing cone for an LCD unit structure 100 as described is larger than ±60° at the contrast ratio of 10:1 in the transmissive part 101, and is around ±60° under a “D65” sunlight condition in the reflective part 102.

In these embodiments, even when polarization absorption axes of the polarization layers 118 and 128 and the half-wave retardation films 116 and 126 all counter-clockwise shift 1° away from the liquid crystal alignment direction, the contrast ratio at the normal incident angle in the transmissive part is still in a range between 75 and 100; the viewing cone at a contrast ratio of 10:1 maintains around ±60°. In the reflective part, the contrast ratio at the normal incident angle is still in a range between 75 and 100, and the viewing cone at the contrast ratio of 10:1 is around ±60°.

In some embodiments where positive biaxial retarders are used as the half-wave retardation films 116 and 126, Nz may be chosen in a range, for example, between −0.5 and 0. In one embodiment, Nz may be −0.1. Under the similar cell configuration and a TFT driving voltage as previously described, the viewing cone for an LCD unit structure 100 as described is around ±60° at the contrast ratio of 10:1 in the transmissive part 101, and is around ±60° under a “D65” sunlight condition in the reflective part 102.

In these embodiments, even when polarization absorption axes of the polarization layers 118 and 128 and the half-wave retardation films 116 and 126 all counter-clockwise shift 1° away from the liquid crystal alignment direction, the contrast ratio at the normal incident angle in the transmissive part is in a range between 75 and 100; the viewing cone at a contrast ratio of 10:1 maintains around ±60°. In the reflective part, the contrast ratio at the normal incident angle is in a range between 75 and 100, and the viewing cone at the contrast ratio of 10:1 is larger than ±50°.

Therefore, in embodiments in which either negative or positive biaxial retarders are used as the half-wave retardation films 116 and 126 in the LCD unit structure 100, a wider viewing angle in both the transmissive part 101 and the reflective part 102 is achieved. In the meantime, the LCD unit structure 100 with biaxial retarders also has a better angular alignment tolerance relative to other optical components in the structure than the similar LCD unit structure 100 but with uni-axial retarders.

2.2 Fringe Field Switching

FIG. 2A illustrates a schematic cross-sectional view of an example NB transflective LCD unit structure 200 in a voltage-off state. As illustrated, the LCD unit structure 200 comprises a transmissive part 201 and a reflective part 202 along the horizontal direction of FIG. 2A. The transmissive part 201 and the reflective part 202 have different layered structures along the vertical direction of FIG. 2A.

The LCD unit structure 200 comprises a layer 210 of homogeneously aligned liquid crystal material. When both the transmissive part 101 and the reflective part 202 comprise structures to operate in an FFS mode as illustrated here, the liquid crystal layer 210 in both the transmissive part 201 and the reflective part 202 may align with a same direction in the voltage-off state. The liquid crystal layer 210 may be filled into a cell space by a capillary effect or a one-drop filling process under the vacuum condition. In some embodiments, the liquid crystal layer 210 is of a positive dielectric anisotropy type with Δ∈>0. In some embodiments, the liquid crystal layer 210 is of a negative dielectric anisotropy type with Δ∈<0.

Color filters 223a may be deposited on or near a surface of a top substrate layer 224. The color filters may cover both the transmissive part 201 and the reflective part 202, or only cover the transmissive part 201. There may be red, green and blue (RGB) color filters 223a deposited on or near the inner surface, which faces the liquid crystal layer 210, of the top substrate layer 224 in the transmissive part 201. In areas that are not covered by the color filters 223a, an over-coating layer 223b may be configured. This over-coating layer 223b may be a passivation layer comprising an organic material such as a-Si:C:O and a-Si:O:F, or an inorganic material such as silicon nitride (SiNx) and silicon oxide (SiO2), prepared by plasma enhanced chemical vapor deposition or other similar sputtering methods.

An in-cell retarder 254, which is equivalent to a half-wave plate, may be inserted between (1) the layer comprising the color filters 223a or the over-coating layer 223b and (2) a second over-coating layer 213. The second over-coating layers 213 may be formed in a plurality of partially etched regions by a photolithographic etching process. In various embodiments, the second over-coating layer 213 may comprise acrylic resin, polyamide, or novolac epoxy resin.

The transmissive part 201 may have a different liquid crystal cell gap than that of the reflective part 202. In some embodiments, in part due to the in-cell retarder 254 and the second over-coating layer 213, the liquid crystal cell gap in the reflective part 202 may be approximately one half of the liquid crystal cell gap in the transmissive part 201.

An ITO layer 222 may be located on or near the inner surface, which faces the liquid crystal layer 210, of a bottom substrate layer 214 as a common electrode 222a. In some embodiments, this ITO layer 222 may cover both the transmissive part 201 and the reflective part 202, or only cover the transmissive part 201. In some embodiments, a metallic reflective layer 211 such as aluminum (Al) or silver (Ag) may be inserted adjacent to the inner face of the bottom substrate layer 214. In the embodiments in which the ITO layer 222 covers both the transmissive part 201 and the reflective part 202, the metallic reflective layer 211 may be deposited on the top surface of the ITO layer 222. In some embodiments, this metallic reflective layer 211 may be a bumpy metal layer. On top of the ITO layer 222 in the transmissive part 201 and the reflective layer 211, an electrically insulating passivation layer 252 may be deposited.

An ITO layer 212 may be deposited to on top of the passivation layer 252. This ITO layer 212 may form a perforated pattern comprising a plurality of regular shapes such as stripes or circles, rectangles, etc. A conductive material is deposited substantially only in the regular shapes of patterns. In some embodiments, these regular shapes of patterns in the ITO layer 212 is electrically insulated or otherwise separated by a gap of a non-conductive material, for example, a dielectric material or simply the liquid crystal material from the layer 210.

A bottom linear polarization layer 216 and a top linear polarization layer 226 with orthogonal polarization axes may be attached on outer surfaces of the bottom substrate layer 214 and top substrate layer 224 respectively.

In some embodiments, the perforated pattern in the ITO layer 212 may comprise two separate independent perforated sub-patterns. The two separate independent perforated sub-patterns may be used as a transmissive electrode for the transmissive part 201 and a reflective electrode for the reflective part 202, respectively. A switching element may be configured in the unit structure 200 to control whether the reflective electrode is connected or disconnected with the transmissive electrode in the transmissive part 201. For example, in some operating modes of a transflective LCD display comprising the LCD unit structure 200, the switching element, working in conjunction with display mode control logic, may cause the reflective electrode to be connected to the transmissive electrode; hence, the reflective and transmissive electrodes may be driven by a same signal to cause the transmissive part 201 and the reflective part 202 to simultaneously express a same pixel or sub-pixel value. In some other operating modes, on the other hand, the switching element may cause the reflective electrode to be disconnected from the transmissive electrode; hence, the reflective and transmissive electrodes may be driven by separate signals to cause the transmissive part 201 and the reflective part 202 to independently express different pixel or sub-pixel values. For example, in a transmissive operating mode, the transmissive part 201 may be set according to a pixel or sub-pixel value based on image data, while the reflective part 202 may be set in a dark black state. In a reflective operating mode, on the other hand, the reflective part 202 may be set according to a pixel or sub-pixel value based on image data, while the transmissive part 201 may be set in a dark black state.

The switching element may be implemented by one or more TFTs hidden beneath the metallic reflective layer 211 in the reflective part 202 to improve the aperture ratio of the transflective LCD.

In some embodiments, in the voltage-off state, the homogeneously aligned liquid crystal layer 210 may be aligned in a direction such that the liquid crystal layer 210 in the transmissive part 201 is substantially a half-wave plate, which slow axis is typically along the absorption axis of the top linear polarization layer 226, while the liquid crystal layer 210 in the reflective part 202 is substantially a quarter-wave plate. In different embodiments, liquid crystal materials with different electrically controllable birefringence properties may be used in the liquid crystal layer 210. In some embodiments, rubbed polyimide layers, not shown in FIG. 2A, may be formed between one of ITO layers 212, 222, and the metallic reflective layer 211 and the liquid crystal layer 210 to induce the liquid crystal layer 210 near the rubbed polyimide layers to be homogeneously aligned along a rubbing direction in parallel with the planar surfaces of the substrate layers 214 and 224.

Since the liquid crystal layer 210 is aligned parallel to the polarization axis of the top linear polarization layer 226 in the voltage-off state, since the liquid crystal layer 210 is aligned orthogonal to the polarization axis of the bottom linear polarization 216 in the voltage-off state, backlight 232 from a BLU through the bottom polarization layer 216 is blocked by the top polarization layer 226 in the voltage-off state. This produces a normally black liquid crystal mode for the transmissive part 201 of the LCD unit structure 200.

In the reflective part 202, the light path of ambient light 242 crosses the liquid crystal layer 210 twice. Since the liquid crystal layer 210 and in-cell retarder 254 in the reflective part 202 form a broadband quarter-wave plate in the voltage-off state, the total effect after the light path of the ambient light 242 crosses the liquid crystal layer 210 and in-cell retarder 254 twice is the crossing of a half-wave plate. Under a similar analysis to that for the reflective part 101 of FIG. 1A, the ambient light 242 is blocked in the reflective part 202 in the voltage-off state. Thus, a normally black liquid crystal mode for the reflective part 202 of the LCD unit structure 200 is also produced.

In some embodiments, in the reflective part 216, the in-cell retarder 254 has an azimuth angle of, for example, θₕ. In the voltage-off state, the liquid crystal layer 210 is a quarter-wave plate with an azimuth angle of, for example, θ_{q}. As described, the in-cell retarder 254 and the liquid crystal layer 210 form a wideband quarter-wave plate. Since the optical path of the ambient light 242 crosses the in-cell retarder 254 and the liquid crystal layer 210 twice, the optical configuration of the reflective part 202 effectively comprises two broadband quarter-wave with the same azimuth angles θₕ and θ_{q}. Depending on a choice of an optimized central wavelength in the visible range from 380 nm to 780 nm, a retardation value of the broadband quarter-wave plates may be configured with a value between 160 nm and 400 nm Further, in some embodiments, the azimuth angles θₕ and θ_{q} may be configured to satisfy one of the two relationships as follows:

60≦4θₕ−2θ_{q}≦120, (Rel. 2a)

or

−120≦4θₕ−2θ_{q}≦−60 (Rel. 2b)

In some embodiments, to realize a pair of achromatic broadband quarter-wave plates in the reflective part, the azimuth angles θₕ and θ_{q} may be configured to substantially satisfy a specific relationship as follows:

4θₕ−2θ_{q}=±90. (Rel. 2c)

To reduce the color dispersion of the liquid crystal layer 210 in the voltage-off state, θ_{q} may be configured to be 0° from the rubbing direction and 10° relative to a longitudinal direction of the striped ITO layer 212, with an angular variation of ±5°. In some embodiments, θₕ is set at around ±77.5° based on the relationship Rel.2c.

FIG. 2B illustrates a schematic cross-sectional view of the example NB transflective LCD unit structure 200 in a voltage-on state.

As illustrated in FIG. 2B, in the transmissive part 201, in the voltage-on state, a fringe field effect exists between the common electrode and the transmissive electrode to twist liquid crystal molecules above the transmissive electrode to cause the whole or a part of backlight to pass through the second polarization layer 226, resulting in a bright state.

When the reflective part 202 is in the voltage-on state, a fringe field effect exists between the common electrode and the reflective electrode, which is a portion of the ITO layer 212, to twist liquid crystal molecules above the reflective electrode to cause the liquid crystal layer 210 in the reflective part 201 no longer to be a quarter-wave plate. Consequently, the ambient light 242, which is blocked in the voltage-off state, can now be reflected off from the metallic reflective layer 211 to show a bright state in the reflective part 202.

The voltage-on state of the transmissive part 201 and the voltage-on state of the reflective part 202 may be independently set. For example, when the switching element causes the reflective electrode to connect to the transmissive electrode, both the transmissive part 201 and the reflective part 202 may be set to a correlated brightness state based on a same pixel value. When the reflective electrode is disconnected to the transmissive electrode, the transmissive part 201 may be set to a first brightness state while the reflective part 202 may be independently set to a second different brightness state.

In some embodiments, color images can be displayed in combination with the R.G.B. color filters 223a in the transmissive part 201 in the transmissive or transflective operating modes, while black and white monochromic images can be shown in the reflective part 202 in the reflective operating modes.

In one embodiment, the liquid crystal layer 210 is made of MLC-6609 commercially available from Merck. The parameters for the liquid crystal layer 210 are: birefringence Δn=0.0777 (at λ=550 nm), and a dielectric anisotropy Δ∈<0. The liquid crystal layer 210 has horizontal alignment with a rubbing angle of 10° in the initial voltage-off state relative to the longitudinal direction of the striped ITO 212. The thickness of the passivation layer 252 is 0.15 um. The width of each electrode element, e.g., an ITO strip, is 3 um while the distance between two neighboring ITO strips is also 3 um. Table 2 shows additional parameters for the LCD unit structure in the embodiment, with an area ratio 40:60 between the transmissive part 201 and the reflective part 202.

TABLE 2

| Components | | Example value |
|---|---|---|
| Polarization layer 226 | absorption axis (°) | 10 |
| In-cell retarder 254 | slow axis direction (°) | 77.5 |
| | phase retardation (nm) | 275 |
| LC layer 21 0 in transmissive | alignment direction (°) | 10 |
| part 201 | cell gap (μm) | 4 |
| LC layer 210 in reflective part | alignment direction (°) | 10 |
| 202 | cell gap (μm) | 1.8 |
| Polarization layer 216 | absorption axis (°) | 100 |

The maximum normalized transmittance for the trasnfelctive LCD unit structure 200 with the above example parameter values is 79.00%, 94.57% and 94.68% to the RGB primaries. The normalized reflectance for the trasnfelctive LCD unit structure 200 at 7 Vrms is 90.81%, 93.86% and 90.71% at λ=450 nm, 550 nm and 650 nm, respectively.

In the transmissive part 201, the NB transflective LCD 200 with an applied voltage between 0 Vrms and 5 Vrms and white light emitting diodes (LEDs) as the BLU achieves a high contrast ratio of 500:1 at the normal incident direction and at view cone of around ±30°. A wide viewing angle can be obtained with a contrast ratio bar of 10:1 of around ±80°.

The NB transflective LCD 200 under “D65” ambient light conditions with the obliquely incident angle of 45° and with an applied voltage between 0 Vrms and 5 Vrms in the reflective part can realize a contrast ratio of 10:1 at a wide view cone of around ±35°, and a contrast ratio of larger than 1 nearly on the whole display view cone of ±80°.

Conventional NB transflective FFS or IPS LCDs use circular polarization layers and one or more wide-band quarter-wave film. The cost of using, including assembling and aligning, large-size circular polarizers and wideband quarter-wave films in these conventional LCDs is much higher than that of using a pair of linear polarization layers and an in-cell retarder 254 in the LCD unit structure 200. Further, as circularly polarized backlight is blocked in reflective parts, it is difficult to recycle backlight in conventional LCDs. Accordingly, the output efficiencies of conventional LCDs suffer, when areas of the reflective parts are comparable to those of transmissive parts.

The LCD unit structure 200, on the other hand, exhibits high contrast ratios and wide viewing angles. A light recycling/redirecting film may also be added between the BLU and the bottom polarization layer 218 to recycle backlight from the reflective part 202 into the transmissive part 201, as further explained, resulting in a high optical output efficiency of the BLU in a display using the LCD unit structure 200, even when the areas of the transmissive part 201 and the reflective part 202 are comparable.

2.3 Flower-Like Electrode Configuration

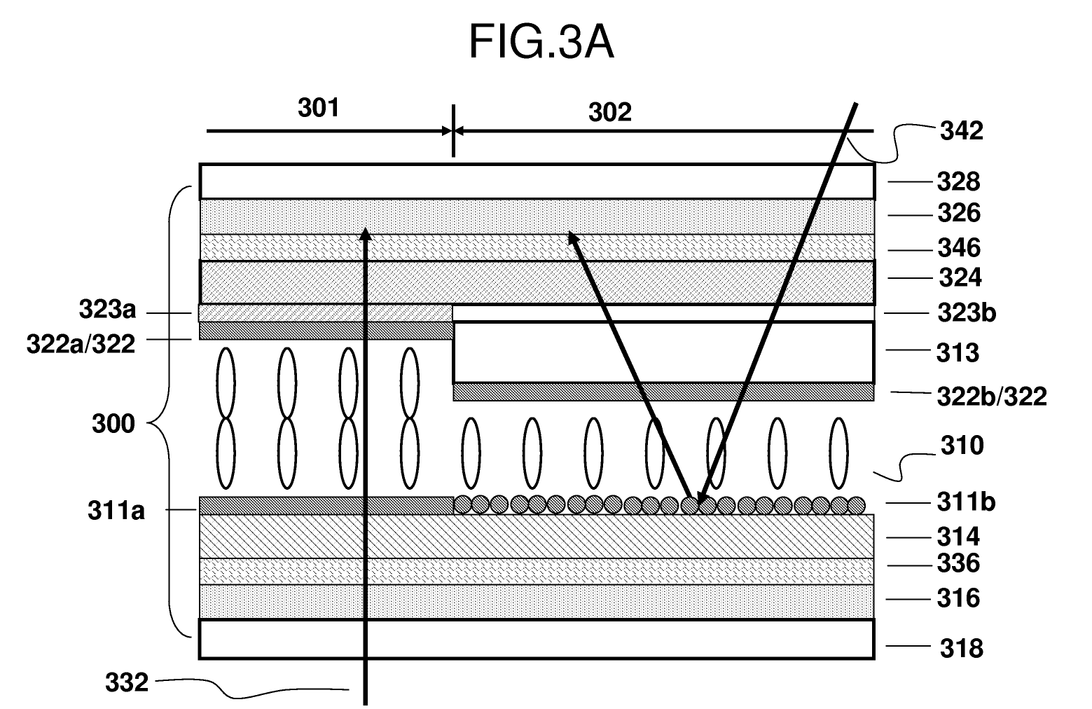

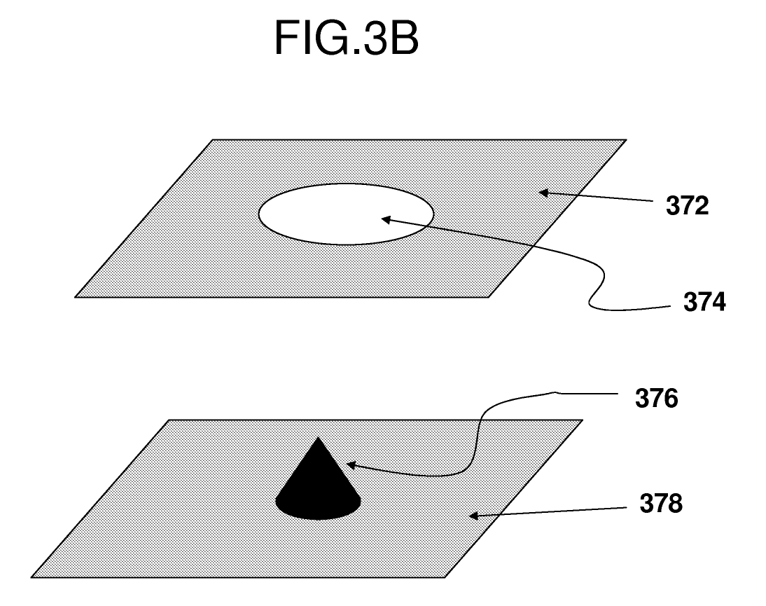

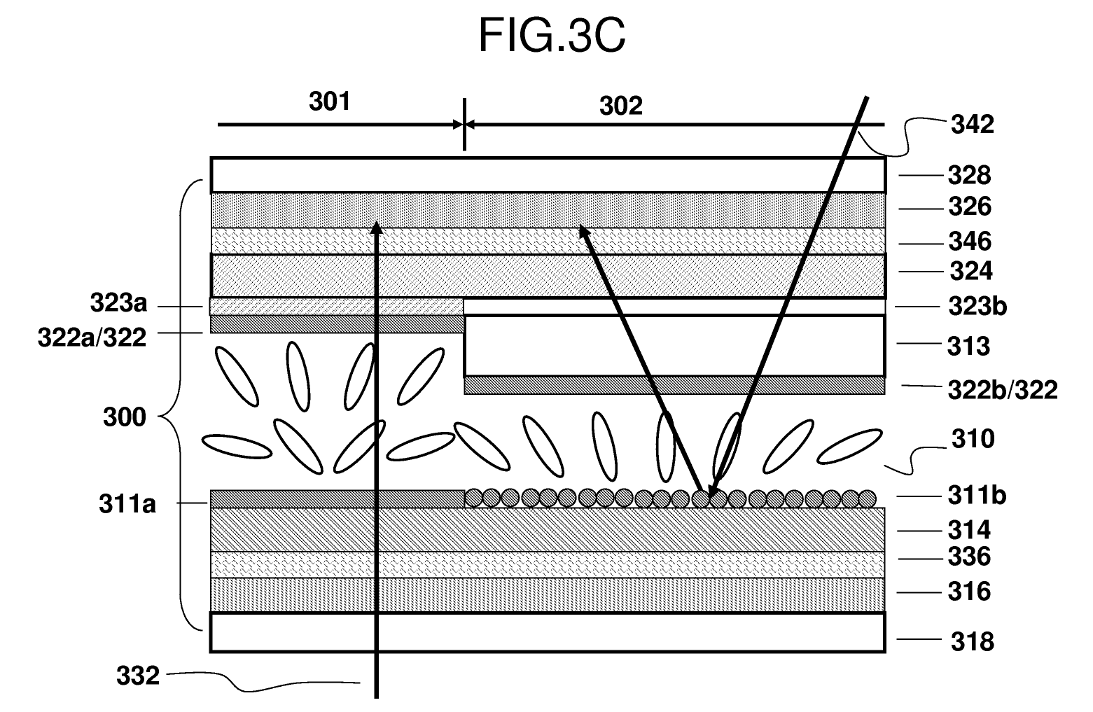

FIG. 3A illustrates a schematic cross-sectional view of an example NB transflective LCD unit structure 300 in a voltage-off state. As illustrated, the LCD unit structure 300 comprises a transmissive part 301 and a reflective part 302 along the horizontal direction of FIG. 3A. The transmissive part 301 and the reflective part 302 have different layered structures along the vertical direction of FIG. 3A.

The LCD unit structure 300 comprises a layer 310 of homogeneously aligned liquid crystal material. When both the transmissive part 301 and the reflective part 302 comprise structures to operate in an FEC mode as illustrated here, the liquid crystal layer 310 in both the transmissive part 301 and the reflective part 302 may align with a same direction in the voltage-off state. The liquid crystal layer 310 may be filled into a cell space by a capillary effect or a one-drop filling process under the vacuum condition. In some embodiments, the liquid crystal layer 310 is of a positive dielectric anisotropy type with Δ∈>0. In some embodiments, the liquid crystal layer 310 is of a negative dielectric anisotropy type with Δ∈<0.

Color filters 323a may be deposited on or near the inner surface, which faces the liquid crystal layer 310, of a top substrate layer 324. The color filters may cover both the transmissive part 301 and the reflective part 302, or only cover the transmissive part 301. There may be red, green and blue (RGB) color filters 323a. In areas that are not covered by the color filters 323a, an over-coating layer 323b may be configured. This over-coating layer 323b may be a passivation layer comprising an organic material such as a-Si:C:O and a-Si:O:F, or an inorganic material such as silicon nitride (SiNx) and silicon oxide (SiO2), prepared by plasma enhanced chemical vapor deposition or other similar sputtering methods.

The transmissive part 301 may have a different liquid crystal cell gap than that of the reflective part 302. In some embodiments, the LCD unit structure 300 comprises an over-coating layer 313 near a top substrate layer 314 in the reflective part 302. The over-coating layer 313 may be formed in a plurality of partially etched regions by a photolithographic etching process. In some embodiments, in part due to the over-coating layer 313, the liquid crystal cell gap in the reflective part 302 may be approximately half of the liquid crystal cell gap in the transmissive part 301. In various embodiments, the over-coating layer 313 may comprise acrylic resin, polyamide, or novolac epoxy resin.

An ITO layer 322a may be located between the top substrate layer 324 and the liquid crystal layer 310 as a first part of a common electrode 322. An ITO layer 322b may be located between the over-coating layer 313 and the liquid crystal layer 310 as a second part of the common electrode 322.

The bottom substrate layer 314 may be made of glass. In the transmissive part 301, on the inner surface, which faces the liquid crystal layer 310, of the bottom substrate layer 314, a transparent indium-tin oxide (ITO) layer 312 may be provided as a transmissive electrode.

In the reflective part 302, the inner surface of the bottom substrate layer 314 may be covered with a metallic reflective layer 311b such as aluminum (Al) or silver (Ag) to work as a reflective electrode. In some embodiments, this metallic reflective layer 311b may be a bumpy metal layer.

A bottom linear polarization layer 316 and a top linear polarization layer 326 with substantially the same polarization axis may be attached on outer surfaces of the bottom substrate layer 314 and top substrate layer 324 respectively.

A switching element may be configured in the unit structure 300 to control whether the reflective electrode 311a is connected or disconnected with the transmissive electrode 312a in the transmissive part 301. For example, in some operating modes of a transflective LCD display comprising the LCD unit structure 300, the switching element, working in conjunction with display mode control logic, may cause the reflective electrode 311a to be connected to the transmissive electrode 312a; hence, the electrodes 311a and 312a may be driven by a same signal to cause the transmissive part 301 and the reflective part 302 to simultaneously express a same pixel or sub-pixel value. In some other operating modes, the switching element may cause the reflective electrode 311a to be disconnected from the transmissive electrode 312a; the electrodes 311a and 312a may thus be driven by separate signals to cause the transmissive part 301 and the reflective part 302 to independently express different pixel or sub-pixel values. For example, in a transmissive operating mode, the transmissive part 301 may be set according to a pixel or sub-pixel value based on image data, while the reflective part 302 may be set in a dark black state. In a reflective operating mode, on the other hand, the reflective part 302 may be set according to a pixel or sub-pixel value based on image data, while the transmissive part 301 may be set in a dark black state.

The switching element may be implemented by one or more TFTs hidden beneath the metallic reflective layer 311 in the reflective part 302 to improve the aperture ratio of the transflective LCD.

In some embodiments, in the voltage-off state, the homogeneously aligned liquid crystal layer 310 may be aligned in a direction. In different embodiments, liquid crystal materials with different electrically controllable birefringence properties may be used in the liquid crystal layer 310. In some embodiments, rubbed polyimide layers are not used in the LCD unit structure 100. In some embodiments, the alignment direction of the liquid crystal layer 310 is vertical as illustrated in FIG. 3A.

In some embodiments, a first half-wave retardation film 316 and a first quarter-wave retardation film 336 are placed over the bottom substrate 316. The ordering of these retardation films 316 and 336 may be as shown or reversed. Similarly, a second half-wave retardation film 326 and a second quarter-wave retardation film 346 are placed below the bottom substrate layer 314. The ordering of these retardation films 326 and 346 may be as shown or reversed. Slow axis directions of the first and second half-wave retardation films 316 and 326 may be substantially along a first direction. Slow axis directions of the first and second quarter-wave retardation films 336 and 346 may be substantially along a second direction.

Backlight 332 from a BLU with a first polarization state when exiting from the first polarization layer 318 turns into a light with a second orthogonal polarization state when entering the second polarization layer 328. The light with this second orthogonal polarization state is blocked by the polarization layer 328. This produces a normally black liquid crystal mode for the transmissive part 301 of the LCD unit structure 300.

In the reflective part 302, the light path of ambient light 342 crosses the second half-wave film 326 and the second quarter-wave film 346 twice. The total effect of these retardation films relative to the light path of the ambient light 342 is a half-wave plate. Under a similar analysis to that for the reflective part 101, the ambient light 342 is blocked in the reflective part 302 in the voltage-off state. Thus, a normally black liquid crystal mode for the reflective part 302 of the LCD unit structure 300 is also produced.

In some embodiments, azimuth angles of the first half-wave retardation film 316 and the second half-wave retardation film 326 are the same, for example, θₕ. Similarly, in some embodiments, azimuth angles of the first quarter-wave retardation film 336 and the second quarter-wave retardation film 346 are the same, for example, θ_{q}. The first half-wave retardation film 316 and the first quarter-wave retardation film 336 form a wideband quarter-wave plate, while the second half-wave retardation film 326 and the second quarter-wave retardation film 346 form another wideband quarter-wave plate. Thus, the optical configuration of the transmissive part 301 comprises two wideband quarter-wave plates as described.

Similarly, in the reflective part 316, only the second half-wave retardation film 326 and the first quarter-wave retardation film 336 are in the optical path of the ambient light 342. The azimuth angles of the second half-wave retardation film 326 and the first quarter-wave retardation film 336 are θₕ and θ_{q}, respectively. Since the optical path of the ambient light 342 crosses the second half-wave retardation film 326 and the first quarter-wave retardation film 336 twice, the optical configuration of the reflective part 302 effectively also comprises two broadband quarter-wave with the same azimuth angles θₕ and θ_{q}. Depending on a choice of an optimized central wavelength in the visible range from 380 nm to 780 nm, a retardation value of the broadband quarter-wave plates may be configured with a value between 160 nm and 400 nm. Further, in some embodiments, the azimuth angles θₕ and θ_{q} may be configured to satisfy one of the two relationships as follows:

60≦4θₕ−2θ_{q}≦120, (Rel. 3a)

or

−120≦4θₕ−2θ_{q}≦−60 (Rel. 3b)

In some embodiments, to realize a pair of achromatic broadband quarter-wave plates in both the transmissive and reflective part, the azimuth angles θₕ and θ_{q} may be configured to substantially satisfy a specific relationship:

4θₕ−2θ_{q}=±90. (Rel. 3c)

Since the polarizer pair is aligned parallel instead of perpendicular to each other, since the optical configurations of the transmissive part 301 and the reflective 302 substantially coincide, the LCD unit structure 300 exhibits a better gamma curve matching ability between the transmissive and reflective modes than otherwise.

In some embodiments, the LCD unit structure 300 comprises a flower-like electrode configuration that generates an electric field resembling a plurality of flower-shapes in the voltage-on state. In some embodiments, this electrode configuration comprises a plurality of micro-protrusions on one of (1) the common electrode 322 and (2) the transmissive electrode 311a or the reflective electrode 311b; and a plurality of openings on the other electrode. In some embodiments, each opening is a symmetric shape such as circle, rectangle, hexagon, octagon, etc. In some embodiments, the micro-protrusions are formed on the electrode layer that is closer to the bottom substrate layer 314, while the openings are formed on the electrode layer that is closer to the top substrate layer 324.

In some embodiments, the electrode configuration of the LCD unit structure 300 forms a plurality of electrode substructures. In some embodiments, electrode substructures in the transmissive part 301 resemble one another, while electrode substructures in the reflective part 302 resemble one another. FIG. 3B illustrates an example electrode substructure comprising a first electrode portion 372 and a second counterpart electrode portion 378. In one embodiment, the first electrode portion 372 is located in the common electrode 322, while the second electrode portion 378 is located in either the transmissive electrode 311a or the reflective electrode 311b. The first electrode portion 372 comprises an opening 374 that is void of a conductive material such as ITO. A micro-protrusion 376 is formed on the second electrode portion 378.

The micro-protrusion 376 may comprise either a transparent material or a non-transparent material. In some embodiments, the micro-protrusion 376 may comprise a dielectric material. The dielectric material may have a dielectric constant that is different from that of the liquid crystal layer 310. The dielectric material may have a refractive index the same as or different from that of the liquid crystal layer 310.

The micro-protrusion 376 may comprise a conical surface that may or may not be coated with a conductive layer. If coated, the conductive layer in the conical surface of the micro-protrusion 376 may be a transparent conductive layer or a non-transparent metallic layer; the conductive layer may or may be connected to the second electrode portion 378.

In various embodiments, the shape, size and area of an opening as described herein may be different in the transmissive part 301 from the counterparts in the reflective part 302. In some embodiments, the area of an opening in the reflective part 302 is larger than that in the transmissive part 301.

FIG. 3C illustrates a schematic cross-sectional view of the example NB transflective LCD unit structure 300 in a voltage-on state.

As illustrated in FIG. 3C, in the transmissive part 301, in the voltage-on state, the homogenously aligned Liquid crystal layer 310 will be twisted up by the electric field created by the electrode configuration due to dielectric anisotropy of the liquid crystal material in layer 310. The twisting of the liquid crystal material in layer 310 induces an optical anisotropic change. Consequently, the backlight 332 can now pass through the polarization layers 318 and 328 to show a bright state in the transmissive part 301.

Similarly, in the reflective part 302, in the voltage-on state, the homogenously aligned Liquid crystal layer 310 will be twisted up by the electric field created by the electrode configuration due to dielectric anisotropy of the liquid crystal material in layer 310. The twisting of the liquid crystal material in layer 310 induces an optical anisotropic change. Consequently, the ambient light 342 can now be reflected off from the metallic reflective layer 311 to show a bright state in the reflective part 302.

The voltage-on state of the transmissive part 301 and the voltage-on state of the reflective part 302 may be independently set. For example, when the reflective electrode 311a is connected to the transmissive electrode 312a, both the transmissive part 301 and the reflective part 302 may be set to a correlated brightness state. When the reflective electrode 311a is disconnected to the transmissive electrode 312a, the transmissive part 301 may be set to a first brightness state while the reflective part 302 may be set to a second different brightness state.

In some embodiments, color images can be displayed in combination with the R.G.B. color filters 323a in the transmissive part 301 in the transmissive or transflective operating modes, while black and white monochromic images can be shown in the reflective part 302 since there are no color filters on this region in the reflective operating modes.

In one embodiment, the liquid crystal layer 310 is made of MLC-6608 commercially available from Merck. As described, the LCD unit structure 200 may comprise the plurality of electrode substructures such as the one illustrated in FIG. 3B, and have a cell gap of 4 μm in the transmissive part 301 and 2.5 μm in the reflective part 302. In this embodiment, the unit areas of the electrode substructures are the same, for example, 28 μm×28 μm. The unit areas of the openings may be 8 μm. The micro-protrusions have diameters of 9 μm and heights of 2.5 μm. The parameters for the liquid crystal layer 310 are: birefringence Δn=0.083 (at λ=550 nm), and a dielectric anisotropy Δ∈<0. The liquid crystal layer 310 has vertical alignment in the initial voltage-off state. The pre-tilt angle for the liquid crystal layer 310 is 90°. Table 3 shows additional parameters for the LCD unit structure in the embodiment, with an area ratio 40:60 between the transmissive part 301 and the reflective part 302.

TABLE 3

| Components | | Example value |
|---|---|---|
| Polarization layer 318 | absorption axis (°) | 0 |
| Half-wave film 316 | slow axis direction (°) | 15 |
| | phase retardation (nm) | 275 |
| Quarter-wave film 336 | slow axis direction (°) | 75 |
| | phase retardation (nm) | 138 |
| Quarter-wave film 346 | slow axis direction (°) | 75 |
| | phase retardation (nm) | 138 |
| Half-wave film 326 | slow axis direction (°) | 15 |
| | phase retardation (nm) | 275 |
| Polarization layer 328 | absorption axis (°) | 0 |

The maximum normalized transmittance for the LCD unit structure 300 with the above example parameter values is 73.8%, 89.1% and 87.4% to the RGB primaries, respectively. The maximum normalized transmittance for an example conventional four-domain transflective VA LCD using the zigzag shaped slits is 61.1%, 74.5% and 75.4% at λ=450 nm, 550 nm and 650 nm, respectively. The NB transflective LCD unit structure 300 has a gain of 20.78%, 19.59% and 15.91% in transmittance of the RGB primaries over those of the conventional four-domain transflective VA LCD. The NB transflective LCD unit structure 300 has a maximum normalized reflectance of 96.10% at the white light source, while that of the conventional four-domain transflective VA LCD has a maximum normalized reflectance of 82.95%. Therefore, the NB transflective LCD 300 has a gain of 15.8% in reflectance over that of the conventional four-domain transflective VA LCD.

In the transmissive part 301, the NB transflective LCD 300 with an applied voltage between 0 Vrms and 5 Vrms and white light emitting diodes (LEDs) as the BLU achieves a high contrast ratio of 500:1 at the normal incident direction and at a view cone of around ±20°. A contrast ratio bar of 10:1 is expanded of around ±50°.

The NB transflective LCD 300 under “D65” ambient light conditions and with an applied voltage between 0 Vrms and 5 Vrms in the reflective part can realize a contrast ratio of 10:1 at a wide view cone of around ±50°, and a contrast ratio of larger than 1 nearly on the whole display view cone of ±70°.

To illustrate a clear example, the plurality of openings may be located near one of the bottom substrate layer and the top substrate layer. In some embodiments, openings may be located in electrode layers near both substrate layers. To illustrate a clear example, openings may be of symmetric shapes. In some embodiments, openings may be of non-symmetric shapes.

3. Backlight Recirculation

In some embodiments, the LCD unit structures described herein may comprise an arrangement for backlight recirculation.

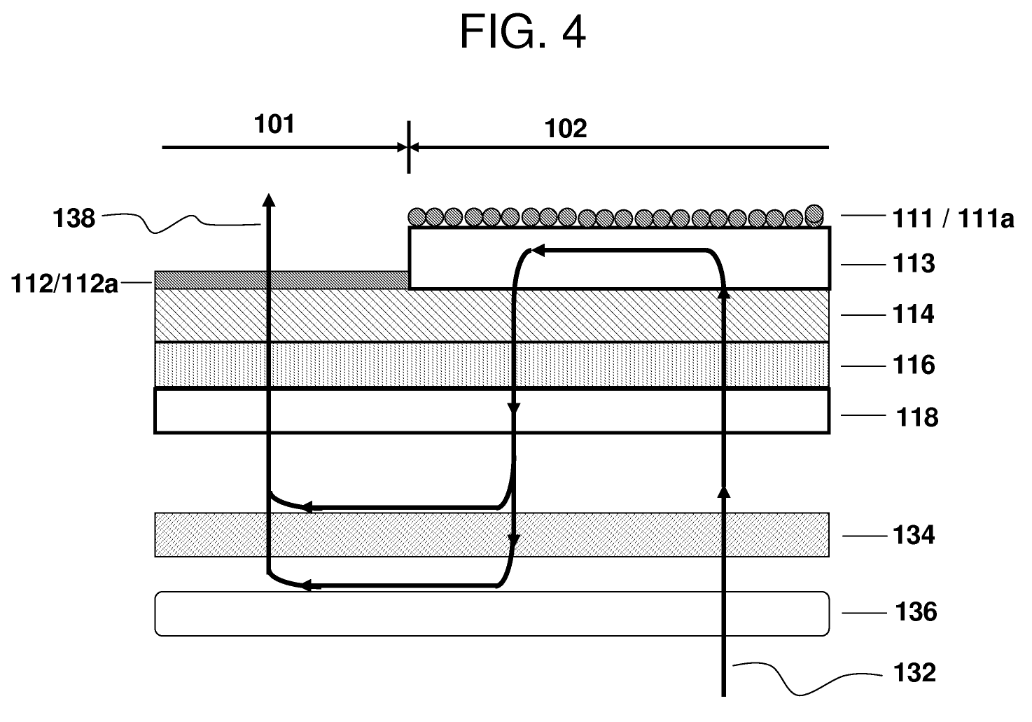

FIG. 4 illustrates an example arrangement for the LCD unit structure 100. As illustrated, a light recycling/redirecting film 134 may be inserted between a BLU 136 and the bottom polarization layer 118. The light recycling/redirecting film 134 may be a polarization recycling film such as a dual brightness enhancement film (DBEF) commercially available from 3M. The light recycling/redirecting film 134 reflects light in a first polarization state and transmits light in a second orthogonal polarization state. In some embodiments, the light recycling/redirecting film 134 may redirect light incident from any incoming direction to a specific range of outgoing directions. The redirection of the incident light may be accomplished by one or more refractions and/or reflections of the light inside the film.

In the reflective part 102, backlight 132 from BLU 136 first passes through the light recycling film 134, the linear polarization layer 118, and the half wave retardation film 116, and enters the bottom region of the reflective part 102 with a first polarization state. The light may be randomly reflected by the reflective layer 111. The reflected light may pass through the half wave retardation film 116 and exits the linear polarization layer 118 with the same first polarization state. By the reflection and redirecting of the light recycling/redirecting film 134 and even the surface of the BLU 136, the backlight 132 is redirected into the transmissive part 101. Thus, the backlight from the BLU in the reflective part 102 is recycled into the transmissive part 101. In some embodiments, through this backlight recirculation, 20˜50% more light can be redirected into the transmissive part 101 from the reflective part 102, which would otherwise be wasted in other conventionally transflective LCD. Therefore, a high optical output of the BLU can be obtained with enhanced brightness in the transmissive part 101.

To illustrate a clear example, the LCD unit structure 100 is used to illustrate the backlight recycling. In some embodiments, the LCD unit structures 200 and 300 use the same or a similar structure as described for backlight recycling.

3. Extensions and Variations

To illustrate a clear example, a transmissive part and a reflective part in a transflective LCD unit structure have been described as operating in one of the ECB, FFS, or FEC modes. In some embodiments, a transflective LCD unit structure may operate in a hybrid mode. In these embodiments, a transmissive part of the transflective LCD unit structure may comprise a transmissive structure as previously described to operate in one of the ECB, FFS, or FEC modes, while a reflective part of the same transflective LCD unit structure may comprise a reflective structure as previously described to operate in a different one of the ECB, FFS, or FEC modes. For example, the transmissive part may have the same structure as that of the transmissive part 201, while the reflective part may have the structure as that of the reflective part 102. Alternatively and/or optionally, the transmissive part may have the same structure as that of the transmissive part 101, while the reflective part may have the structure as that of the reflective part 202. Alternatively and/or optionally, the transmissive part may have the same structure as that of the transmissive part 301, while the reflective part may have the structure as that of the reflective part 102. Other different combinations of a transmissive part and a reflective part in a transflective LCD unit structure may also be used. As noted before, a liquid crystal layer remains homogeneously aligned to a same direction within each of the transmissive part and the reflective part in the voltage-off state. However, the liquid crystal layer portion in the transmissive part may or may not be aligned with the liquid crystal layer portion in the reflective part in the voltage-off state.

LCD unit structures as described herein may be used for expressing different colors. The parameters for an LCD unit structure that is used to express one color may be different from those for another LCD unit structure that is used to express another color, even if both LCD unit structures are part of a same display panel. For example, cell gaps for an LCD unit structure for a “green” color may be different from those for another LCD unit structure for a “red” color, even if both LCD unit structures belong to a same pixel in a same LCD display.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention, as described in the claims.

What is claimed is:

1. A transflective liquid crystal display comprising a plurality of unit structures, each unit structure comprising:
a reflective part, comprising:
first portions of a first polarizing layer, a second polarizing layer, a first substrate layer, and a second substrate layer, wherein the second substrate layer is opposite to the first substrate layer; a first common electrode portion; a reflective electrode; an over-coating layer adjacent to one of the first substrate layer and the second substrate layer; a reflective layer adjacent to the first substrate layer; a half-wave retardation film;
wherein the first substrate layer and the second substrate layer are between the first polarizing layer and the second polarizing layer;
a first liquid crystal layer portion of a liquid crystal layer between the first substrate layer and the second substrate layer, wherein liquid crystal molecules in the first liquid crystal layer portion is substantially homogeneously aligned along a direction in a voltage-off state;
a transmissive part, comprising:
second portions of the first polarizing layer, the second polarizing layer, the first substrate layer, and the second substrate layer;
a second liquid crystal layer portion of the liquid crystal layer between the first substrate layer and the second substrate layer;
a second common electrode portion; and
a transmissive electrode;
wherein a cell gap of the first liquid crystal layer portion is different from a cell gap of the second liquid crystal layer portion;
wherein liquid crystal molecules in the second liquid crystal layer portion is substantially homogeneously aligned along a second direction in the voltage-off state.

2. The transflective liquid crystal display according to claim 1, wherein the unit structure further comprises at least one color filter that covers at least an area of the transmissive part, wherein the unit structure is configured to express a color value associated with a color of the at least one color filter.

3. The transflective liquid crystal display according to claim 2, wherein the unit structure is a part of a composite pixel, and wherein the composite pixel comprises another unit structure that is configured to express a different color value other than the color value expressed by the unit structure.

4. The transflective liquid crystal display according to claim 1, wherein a normal direction of a surface of the first substrate layer is aligned in parallel with one or more of the first direction and the second direction.

5. The transflective liquid crystal display according to claim 1, wherein the unit structure further comprises one or more orientation films and wherein one or more of the first direction and the second direction are along a rubbing direction of at least one of the one or more orientation films.

6. The transflective liquid crystal display according to claim 1, wherein the half-wave retardation film is an in-cell retardation film that covers substantially only the reflective part.

7. The transflective liquid crystal display according to claim 1, wherein the unit structure comprises a first half-wave film and a second half-wave film, wherein the first half-wave film comprises a first half-wave film portion in the reflective part and a second half-wave film portion in the transmissive part, wherein the second half-wave film comprises a third half-wave film portion in the reflective part and a fourth half-wave film portion in the transmissive part, and wherein the half-wave retardation film is the third half-wave film portion in the reflective part.

8. The transflective liquid crystal display according to claim 6, wherein the second half-wave film is one of a uni-axial retardation film, a biaxial retardation film, or an oblique retardation film.

9. The transflective liquid crystal display according to claim 1, wherein the liquid crystal layer comprises a liquid crystal material which optical birefringence is electrically controllable.

10. The transflective liquid crystal display according to claim 1, wherein the half-wave retardation film and the first liquid crystal layer portion forms a wideband quarter-wave plate in the voltage-off state.

11. The transflective liquid crystal display according to claim 10, wherein the half-wave retardation film has an azimuth angle of θₕ, wherein the first liquid crystal layer portion has an azimuth angle of θ_{q}, and wherein the azimuth angles satisfy one of (1) 60≦4θₕ−2θ_{q}≦120, or (2) −120≦4θₕ−2θ_{q}≦−60.

12. The transflective liquid crystal display according to claim 1, wherein the unit structure comprises a first half-wave film and a second half-wave film, wherein the half-wave retardation film is a first portion of the second half-wave film, wherein the half-wave retardation film and the first liquid crystal layer portion in the voltage-off state forms a wideband quarter-wave plate in the reflective part, wherein a second portion of the second half-wave film and a first half of the second liquid crystal layer portion in the voltage-off state forms a first wideband quarter-wave plate in the transmissive part, and wherein the first half-wave film and a second remaining half of the second liquid crystal layer portion in the voltage-off state forms a second wideband quarter-wave plate in the transmissive part.

13. The transflective liquid crystal display according to claim 12, wherein the first half-wave film has an azimuth angle of θₕ, wherein the first liquid crystal layer portion has an angle of θ_{q}, wherein an azimuth angle of the second half-wave film is substantially θₕ, and wherein the azimuth angles satisfy one of (1) 60≦4θₕ−2θ_{q}≦120, or (2) −120≦4θₕ−2θ_{q}≦−60.

14. The transflective liquid crystal display according to claim 1, wherein the unit structure comprises a first half-wave film, a second half-wave film, a first quarter-wave film, and a second quarter-wave film, wherein the half-wave retardation film is a part of the second half-wave film, wherein the first half-wave film and the first quarter-wave forms a first wideband quarter-wave plate in both the transmissive part and the reflective part, and wherein the second half-wave film and the second quarter-wave forms a second wideband quarter-wave plate in both the transmissive part and the reflective part.

15. The transflective liquid crystal display according to claim 14, wherein the first half-wave film has an azimuth angle of θₕ, wherein the first quarter-wave film has an azimuth angle of θ_{q}, wherein an azimuth angle of the second half-wave film is substantially θₕ, wherein an azimuth angle of the second quarter-wave film is substantially θₕ, and wherein the azimuth angles satisfy one of (1) 60≦4θₕ−2θ_{q}≦120, or (2) −120≦4θₕ−2θ_{q}≦−60.

16. The transflective liquid crystal display according to claim 1, wherein the unit structure comprises a switching element that is configured to control whether the reflective electrode is electrically connected to the transmissive electrode.

17. The transflective liquid crystal display according to claim 1, wherein the common electrode is located on a first side of the liquid crystal layer and the transmissive electrode and the reflective electrode are located on a second opposing side of the liquid crystal layer.

18. The transflective liquid crystal display according to claim 1, wherein the common electrode, the transmissive electrode, and the reflective electrode are located on a same side of the liquid crystal layer, wherein the unit structure further comprises a passivation layer, wherein the common electrode is located on a first side of the passivation layer, and wherein the transmissive electrode and the reflective electrode are located on a second opposing side of the passivation layer.

19. The transflective liquid crystal display according to claim 1, wherein at least one of the common electrode, the transmissive electrode and the reflective electrode is formed by a non-perforated planar layer of a conductive material.

20. The transflective liquid crystal display according to claim 1, wherein at least one of the common electrode, the transmissive electrode, and the reflective electrode is formed by a plurality of discrete conductive components, and wherein two neighboring discrete conductive components is spatially separated by a non-conductive gap.

21. The transflective liquid crystal display according to claim 1, wherein at least one of the common electrode, the transmissive electrode, and the reflective electrode comprises one or more openings each of which is void of a conductive material.

22. The transflective liquid crystal display according to claim 1, wherein one or more micro-protrusions are deposited on at least one of the common electrode, the transmissive electrode, and the reflective electrode.

23. The transflective liquid crystal display according to claim 1, wherein the common electrode comprises one or more openings each of which is void of a conductive material, wherein one or more micro-protrusions are deposited on the transmissive electrode and the reflective electrode, wherein the one or more openings and the one or more micro-protrusions form one or more pairs of electrode substructures each comprising one of the one or more openings and one of the one or more micro-protrusions.

24. The transflective liquid crystal display according to claim 1, wherein the unit structure further comprises a light recycling film between the first substrate layer and a backlight unit that redirects backlight from the reflective part to the transmissive part.

25. The transflective liquid crystal display according to claim 24, wherein the light recycling film is configured to turn incident light of any polarized state into redirected light with a particular polarization state.

26. A computer, comprising:
one or more processors;
a transflective liquid crystal display coupled to the one or more processors and comprising a plurality of unit structures, a unit structure comprising:
a reflective part, comprising:
first portions of a first polarizing layer, a second polarizing layer, a first substrate layer, and a second substrate layer, wherein the second substrate layer is opposite to the first substrate layer; a first common electrode portion; a reflective electrode; an over-coating layer adjacent to one of the first substrate layer and the second substrate layer; a reflective layer adjacent to the first substrate layer; a half-wave retardation film;
wherein the first substrate layer and the second substrate layer are between the first polarizing layer and the second polarizing layer;
a first liquid crystal layer portion of a liquid crystal layer between the first substrate layer and the second substrate layer, wherein liquid crystal molecules in the first liquid crystal layer portion is substantially homogeneously aligned along a direction in a voltage-off state;
a transmissive part, comprising:
second portions of the first polarizing layer, the second polarizing layer, the first substrate layer, and the second substrate layer;
a second liquid crystal layer portion of the liquid crystal layer between the first substrate layer and the second substrate layer;
a second common electrode portion; and
a transmissive electrode;
wherein a cell gap of the first liquid crystal layer portion is different from a cell gap of the second liquid crystal layer portion;
wherein liquid crystal molecules in the second liquid crystal layer portion is substantially homogeneously aligned along a second direction in the voltage-off state.

27. The computer according to claim 26, wherein the unit structure further comprises at least one color filter that covers at least an area of the transmissive part, wherein the unit structure is configured to express a color value associated with a color of the at least one color filter.

28. The computer according to claim 26, wherein the half-wave retardation film is an in-cell retardation film that covers substantially only the reflective part.

29. The computer according to claim 26, wherein the unit structure comprises a first half-wave film and a second half-wave film, wherein the first half-wave film comprises a first half-wave film portion in the reflective part and a second half-wave film portion in the transmissive part, wherein the second half-wave film comprises a third half-wave film portion in the reflective part and a fourth half-wave film portion in the transmissive part, and wherein the half-wave retardation film is the third half-wave film portion in the reflective part.

30. The computer according to claim 26, wherein the liquid crystal layer comprises a liquid crystal material which optical birefringence is electrically controllable.

31. The computer according to claim 26, wherein the half-wave retardation film and the first liquid crystal layer portion forms a wideband quarter-wave plate in the voltage-off state.

32. The computer according to claim 26, wherein the unit structure comprises a first half-wave film and a second half-wave film, wherein the half-wave retardation film is a first portion of the second half-wave film, wherein the half-wave retardation film and the first liquid crystal layer portion in the voltage-off state forms a wideband quarter-wave plate in the reflective part, wherein a second portion of the second half-wave film and a first half of the second liquid crystal layer portion in the voltage-off state forms a first wideband quarter-wave plate in the transmissive part, and wherein the first half-wave film and a second remaining half of the second liquid crystal layer portion in the voltage-off state forms a second wideband quarter-wave plate in the transmissive part.

33. The computer according to claim 26, wherein the unit structure comprises a first half-wave film, a second half-wave film, a first quarter-wave film, and a second quarter-wave film, wherein the half-wave retardation film is a part of the second half-wave film, wherein the first half-wave film and the first quarter-wave forms a first wideband quarter-wave plate in both the transmissive part and the reflective part, and wherein the second half-wave film and the second quarter-wave forms a second wideband quarter-wave plate in both the transmissive part and the reflective part.

34. The computer according to claim 26, wherein the unit structure comprises a switching element that is configured to control whether the reflective electrode is electrically connected to the transmissive electrode.

35. The computer according to claim 26, wherein the common electrode, the transmissive electrode, and the reflective electrode are located on a same side of the liquid crystal layer, wherein the unit structure further comprises a passivation layer, wherein the common electrode is located on a first side of the passivation layer, and wherein the transmissive electrode and the reflective electrode are located on a second opposing side of the passivation layer.

36. The computer according to claim 26, wherein the common electrode comprises one or more openings each of which is void of a conductive material, wherein one or more micro-protrusions are deposited on the transmissive electrode and the reflective electrode, wherein the one or more openings and the one or more micro-protrusions form one or more pairs of electrode substructures each comprising one of the one or more openings and one of the one or more micro-protrusions.

37. The computer according to claim 26, wherein the unit structure further comprises a light recycling film between the first substrate layer and a backlight unit that redirects backlight from the reflective part to the transmissive part.

38. A method of fabricating a transflective liquid crystal display, comprising:
providing a plurality of unit structures, a unit structure comprising:
a reflective part, comprising:
first portions of a first polarizing layer, a second polarizing layer, a first substrate layer, and a second substrate layer, wherein the second substrate layer is opposite to the first substrate layer; a first common electrode portion; a reflective electrode; an over-coating layer adjacent to one of the first substrate layer and the second substrate layer; a reflective layer adjacent to the first substrate layer; a half-wave retardation film;
wherein the first substrate layer and the second substrate layer are between the first polarizing layer and the second polarizing layer;
a first liquid crystal layer portion of a liquid crystal layer between the first substrate layer and the second substrate layer, wherein liquid crystal molecules in the first liquid crystal layer portion is substantially homogeneously aligned along a direction in a voltage-off state;
a transmissive part, comprising:
second portions of the first polarizing layer, the second polarizing layer, the first substrate layer, and the second substrate layer;
a second liquid crystal layer portion of the liquid crystal layer between the first substrate layer and the second substrate layer;
a second common electrode portion; and
a transmissive electrode;
wherein a cell gap of the first liquid crystal layer portion is different from a cell gap of the second liquid crystal layer portion;
wherein liquid crystal molecules in the second liquid crystal layer portion is substantially homogeneously aligned along a second direction in the voltage-off state.

39. The method according to claim 38, wherein the unit structure further comprises at least one color filter that covers at least an area of the transmissive part, wherein the unit structure is configured to express a color value associated with a color of the at least one color filter.

40. The method according to claim 38, wherein the liquid crystal layer comprises a liquid crystal material which optical birefringence is electrically controllable.
